(19) United States
(12) Patent Application Publication
(10) Pub. No.: US 2001/0044282 A1
(43) Pub. Date: Nov. 22, 2001

(54) REMOTELY CONTROLLED, LONG DISTANCE IDENTIFICATION BEACON

(76) Inventor: ROBERT J. LANZA, HEWITT, NJ (US)

Correspondence Address: DAVID A JACKSON, KLAUBER & JACKSON, 411 HACKENSACK AVENUE, HACKENSACK, NJ, 07601

(21) Appl. No.: 08/943,318

(22) Filed: Oct. 8, 1997

Related U.S. Application Data
(63) Continuation-in-part of application No. 29/041,461, filed on Jul. 14, 1995, now Pat. No. D385502.

(51) Int. Cl. H04B 7/00

(52) U.S. Cl. 455/92; 455/128; 455/572

(57) ABSTRACT

A remotely controlled, long distance locating beacon system for locating an object, the system including a transponder for generating at least one beacon signal in response to a respective trigger signal and a remote trigger for generating the trigger signal. The transponder includes a housing having an attachment for fastening the housing to the object, a receiver attached to the housing for receiving the trigger signal, beacon generator attached to the housing for emitting the beacon signal in response to the trigger signal, circuitry disposed within the housing for connecting the receiver and the beacon generator, and a transponder power supply attached to the housing for supplying electrical power to the receiver, the beacon generator, and the circuitry. The remote trigger includes a transmitter for generating the trigger signal, electrical connection circuitry for supplying electrical power to the transmitter, and a switch for selectively controlling the transmitter.

This application is a continuation-in-part of copending application Ser. No. 29/041,461, filed Jul. 14, 1995, all of which is herein incorporated by reference in its entirety. Disclosure Document No. 374510 filed with the U.S. Patent and Trademark Office on Apr. 18, 1995 is also incorporated in its entirety as if fully set out herein.

### FIELD OF THE INVENTION

The present invention relates to devices useful in locating an object, and more particularly, devices which utilize a remote control for activating, from some distance away from the object, a visual and/or audio signal announcing the object, whereby the object can be located by the operator of the remote control.

### BACKGROUND OF THE INVENTION

Devices for assisting in the location of objects would be useful to hunters who track their prey and lay in wait for an opportunity to bring down an often elusive prey. In particular, hunting areas are often forested and the hunter will construct a blind or perch off the ground, up in one of the trees, from which to observe and shoot the prey being hunted. This blind, or place of concealment, which affords some amount of shelter and comfort to the hunter during possibly long periods of waiting may be constructed high enough off the ground to rely on the juncture of the trunk of the tree using one or more of its major limbs for support.

Often, a hunter will construct the perch or blind in advance of the day of hunting so as not to scare off any prey by the construction of the blind. Moreover, hunters typically wish to position themselves within the blind before dawn in order to minimize any movement or commotion around the daybreak period so as to maximize the chance of encountering a desired prey on its unwitting travel past the blind, as the time period surrounding the dawn is a period of high activity for many types of animals.

Furthermore, a hunter would also wish to maximize the chance of finding prey on the opening day of the hunting season, which typically begins at dawn, and at which time the prey is most abundant.

Furthermore, since considerable time and effort are usually expended by the typical hunter in the construction of such a hunting blind, the hunter usually finds it very desirable to reuse the hunting blind which he has constructed, season after hunting season. The particular physical location of the hunting blind, e.g., near trails used by the prey being hunted, especially deer, also makes reuse of the same hunting bind very desirable. However, in order to reuse the same hunting blind, the hunter must have some means of locating that particular hunting blind located in a particular tree of a particular section of a particular forest. With virtually no landmarks available for use as guide posts, the process of locating the same hunting blind can be difficult, confusing, and often unsuccessful.

The present invention achieves the above objects, among other objects, as apparent by the following.

### BRIEF DESCRIPTION OF THE PRIOR ART

Devices have been created heretofore to be used as automobile locating systems, which utilize visual and audio signals and which are remotely controlled. For example, U.S. Pat. No. 3,506,956 issued to E. A. Kolm et al. discloses an autofinder device in which a strobe light is suggested and the light is transmitted throughout a transparent rod and ball mounted on the car's fender. However, unlike the device of the present invention, the remote control is achieved by use of a high-frequency dog whistle whose acoustical signal is recognized by the device.

U.S. Pat. No. 5,278,556 issued to Oh discloses a remote controlled auto-finder which emits light and sound, is attached to a car window by means of suction cups, has mechanical means for moving the light sources, and is housed in a transparent body which is covered with a garment to simulate an animal character. The patent does not disclose any signal-transmitting means which operates over especially long distances and uses a special broadcast band.

Devices have also been created heretofore to be used as locating systems for objects other than automobiles, which utilize visual and audio signals and which are remotely controlled. For example, Owen (U.S. Pat. No. 5,294,915) discloses a means for locating lost or misplaced remote control devices comprising means for generating FM signals, which are located within the stationary electronic device which is controlled by the remote control device. Corresponding means for receiving the FM signals are located within the portable remote control device, as well as means for generating an audible signal in response to the FM signals thus received.

Lander (U.S. Pat. No. 4,476,469) discloses a transmitter-transponder system for short range domestic use comprising a hand-held short-range signal transmitter provided with circuitry for generating an address signal, and a miniature locator comprising a transponder also provided with circuitry for recognizing the address signal, and means for emitting a sound and/or light signal. However, the disclosed device is basically for indoor, not outside use, and is for short-range, not long-range applications.

Devices for use in marking trees have also been provided for in the prior art. For example, Ryder (U.S. Pat. No. 3,685,482) discloses a trail marker formed of readily foldable material having a tie portion reinforced by a length of flexible wire, and a connected tail portion. However, such devices do not suggest the features of long distance remote control and visual and audio signals.

Light reflective markers and marker lamps of various types are also quite common in the prior art. For example, Anderson (U.S. Pat. No. 4,977,851) discloses a light-reflective marker for roadways and the like, comprising a supporting stake over which is telescoped a tubular member with light-reflective material effective on a 360-degree circle around the marker. Hutchisson (U.S. Pat. No. 5,325,271) discloses a marker lamp assembly for use on vehicles comprising a multifaceted prismatic diffuser to which a number of LED's are fitted. These devices utilize a light source or reflected light to mark the presence of some desired object, but do not contemplate the use of a remote control or the attachment to a tree, as in the present invention.

One object of the present invention is to provide a remotely controlled beacon system for locating an object, wherein the remote control can activate a beacon from a long distance.

Another object of the present invention is to provide a beacon system which is suitable for use outdoors.

Still another object of the present invention is to provide a beacon which is detectable even in wooded wilderness areas. It is still another object of the present invention to provide a beacon system which is weather resistant.

Other objects of the present invention, as well as particular features, elements, and advantages thereof will be elucidated in, or be apparent from the following description and the accompanying drawing figures.

### SUMMARY OF THE INVENTION

The present invention provides a remotely controlled, long distance locating beacon for outdoor use, comprising: a weather resistant beacon housing having optionally removable attachment means for fastening said housing to an object to be located thereby, light emitting means energized by electrical current, a source of electrical current contained within said housing, signal receiving means for receiving a radio signal of specific frequency, and circuit means responsive to said radio signal wherein said source of electrical current energizes said light emitting means; and a remote control means which may be held in human hand, comprising signal transmitting means for generating a radio signal of specific frequency, a source of electrical current to energize said signal transmitting means, switching means for controlling said generating of said radio signal, and circuit means responsive to said switching means wherein said source of electrical current energizes said signal transmitting means.

In accordance with the present invention there is further provided the above-described remotely controlled, long distance locating beacon for outdoor use, further comprising: sound emitting means energized by said electrical current in response to said radio signal by way of said signal receiving means, circuit means, and source of electrical current. There is further provided such a locating beacon wherein said weather resistant housing is transparent in that portion thereof enclosing said sound emitting means which provides protection from said weather while at the same time permitting said sound to be emitted; said removable attachment means comprises one or more straps of weather resistant material which have associated means on said weather resistant housing which allow the strap or straps to hold said housing against an object to be located, and which have associated therewith engagement means, whereby said straps may adjustably fasten said housing to said object to be located thereby, said strap preferably having mating fastening means; in a more preferred embodiment said mating fastening means are hook and loop fabric portions available commercially as VELCRO® from the Velcro Corporation; said light emitting means comprises a high intensity light source, preferably a strobe light comprising a flashtube giving repeated high-speed illumination of high intensity; said source of electrical current comprises a solar collector means which is an array of solar cells for converting sunlight to electrical energy, which may be located outside said housing where a large array area is required, or inside said housing which will have a window therein with a transparent covering, associated with a battery contained within said housing for storing said electrical energy until needed to energize said light emitting means and said sound emitting means; said remote control means additionally includes an antenna as part of said signal transmitting means for generating a radio signal of specific frequency; said source of electrical current to energize said signal transmitting means comprises a battery; said switching means for controlling said generating of said radio signal includes an on/off switch for said remote control means, and optionally an on/off switch for said signal generating function in order to conserve electrical energy, and optionally separate switches for said light emitting means and said sound emitting means whereby each may be activated separately responsive to different radio frequency signals from said transmitting means.

### BRIEF DESCRIPTION OF THE DRAWINGS

Understanding of the present invention and the various aspects thereof will be facilitated by reference to the accompanying drawing figures, submitted for purposes of illustration only and not intended to limit the scope of the invention, in which:

FIG. 1 is a top plan view of one embodiment of the present invention comprising a light beacon and a remote control for activating the beacon.

FIG. 2 is a bottom plan view of the embodiment of FIG. 1.

FIG. 3 is a left side elevational view of the embodiment of FIG. 1.

FIG. 4 is a front elevational view of the embodiment of FIG. 1.

FIG. 5 is another embodiment of the present invention comprising a sound and light emitting beacon generator and a remote control.

FIG. 6 is a front view of a light and sound beacon generating member according to yet another embodiment of the present invention.

FIG. 7 is a schematic illustration of the internal components of the beacon generating member of FIG. 6.

FIG. 8 shows a rear view of the beacon generating member of FIG. 6.

FIG. 9 shows a top view of the beacon generating member of FIG. 6.

### DETAILED DESCRIPTION OF THE PREFERRED EMBODIMENTS

Reference should now be made to the drawing figures, on which similar or identical elements are given consistent identifying numerals throughout the various figures thereof, and on which parenthetical references to figure numbers direct the reader to the view(s) on which the element(s) being described is(are) best seen, although the element(s) may also be seen on other view(s).

In one embodiment, the present invention provides a remotely controlled, long distance locating beacon system for locating an object. The system comprises a transponder means for generating at least one beacon signal in response to a respective trigger signal and a remote trigger means for generating the trigger signal.

The transponder means includes a housing having an attachment means for fastening the housing to the object, receiving means attached to the housing for receiving the trigger signal, beacon generation means attached to the housing for emitting the beacon signal in response to the trigger signal, circuit means, disposed within the housing, for connecting the receiving means and the beacon generation means, and transponder power supply means attached to the housing for supplying electrical power to the receiving means, the beacon generation means, and the circuit means.

The remote trigger means includes transmitter means for generating the trigger signal, electrical connection means for supplying electrical power to the transmitter means, and switching means for selectively controlling the transmitter means. Optionally, the remote trigger means may also comprise its own power supply.

The trigger signal is preferably a radio signal within a predetermined frequency range. In one particularly preferred embodiment, the radio signal has a frequency of approximately 900 MHZ.

The beacon generation means may comprise a light emitting means. The light emitting means may further comprise at least one high intensity strobe light.

The light emitting means may be encased by the housing, and the housing may further comprise at least one transparent portion capable of allowing light from the light emitting means to pass therethrough.

The beacon generation means may in addition, or alternately, include a sound emitting means. The sound emitting means may be encased by the housing, in which case the housing should be adapted to allow sound from the sound emitting means to pass therethrough.

The remote trigger means may include a trigger power supply means for supplying electrical power to the transmitter means.

The transponder power supply means may further comprise at least one battery.

Furthermore, the transponder power supply means may include a solar collector means.

In a particular embodiment, the attachment means preferably comprises at least one strap attached to the exterior of the housing.

In another aspect, the present invention provides a remotely controlled, long distance locating beacon system for aiding a user in locating an object which is at least partially obscured. The beacon system comprises a housing having an attachment means for fastening the housing to the object, receiving means attached to the housing for receiving at least one activation radio signal within a specific frequency range, beacon generation means attached to the housing for emitting at least one beacon signal in response to the activation radio signal, the beacon generation means including a high intensity light emitting means, circuit means, disposed within the housing for connecting the receiving means and the beacon generation means, a first power supply means attached to the housing for supplying electricity to the receiving means, the beacon generation means, and the circuit means, and remote control means. The remote control means includes signal transmitting means for generating the activation radio signal so as to be capable of detection by the receiving means when the remote control means is spaced apart from the housing as well as switching means for selectively controlling the signal transmitting means. Preferably, the activation signal is a radio signal of specific frequency.

The light emitting means may be disposed within the housing, in which case the housing further comprises at least one transparent portion capable of allowing light from the light emitting means to pass therethrough.

The beacon generation means may comprise a sound emitting means. The sound emitting means may be disposed within the housing, and the housing may be adapted to allow sound from the sound emitting means to pass therethrough.

The first electrical power supply means may comprise a solar collector means connected to the circuit means.

The remote control means may include a power supply means for supplying electrical power to the signal transmitting means.

The attachment means preferably comprises at least one strap attached to the exterior of the housing.

In yet another aspect, the present invention provides a means for marking a location in a wilderness area, including a signal means disposed at the location for generating at least one beacon signal in response to a respective radio trigger signal having a frequency within a predetermined radio frequency range, wherein the signal means includes a replenishable power supply, and a remote trigger means for generating the trigger signal in response to user input. The power may be supplied by replaceable batteries, rechargeable batteries, and/or solar array means.

Thus, in accordance with the present invention there is provided a remotely controlled, long distance locating beacon 10 for outdoor use. The device of the present invention finds particular use in locating a blind which a hunter has constructed off the ground in a tree from which to observe and shoot the particular prey being hunted. This place of concealment usually represents the expenditure of considerable time and effort by the hunter, and may even contain some personal items which the hunter has chosen to leave there as a matter of convenience. The hunter may rely on the remoteness and concealed character of the blind for securing against its being used or damaged. However, it is this very security against being easily detected or discovered that makes it difficult for the hunter who constructed the blind to be able to locate it in the future for continued use.

Accordingly, the device of the present invention provides a ready and reliable solution to this problem through utilization of a number of unique features which are responsive to parameters imposed by the problem. The first element which poses a challenge is the harsh outdoor environment in which the locating beacon must function. It must be able to withstand weather-related extremes of temperature and humidity, wind, sunlight, as well as physical assaults by falling tree parts and wild animals. To meet this challenge, the housing 12 for the locating beacon 10 is preferably constructed from rugged materials such as synthetic resins, e.g. the engineering resins, designed for their ability to resist these negative factors. These resins include polycarbonate, polystyrene, polyurethane, polyamide, and acrylonitrilebutadiene-styrene resins and various copolymer, terpolymer combinations thereof. The housing for the locating beacon should be capable of easy assembly and disassembly, and yet be weather proof.

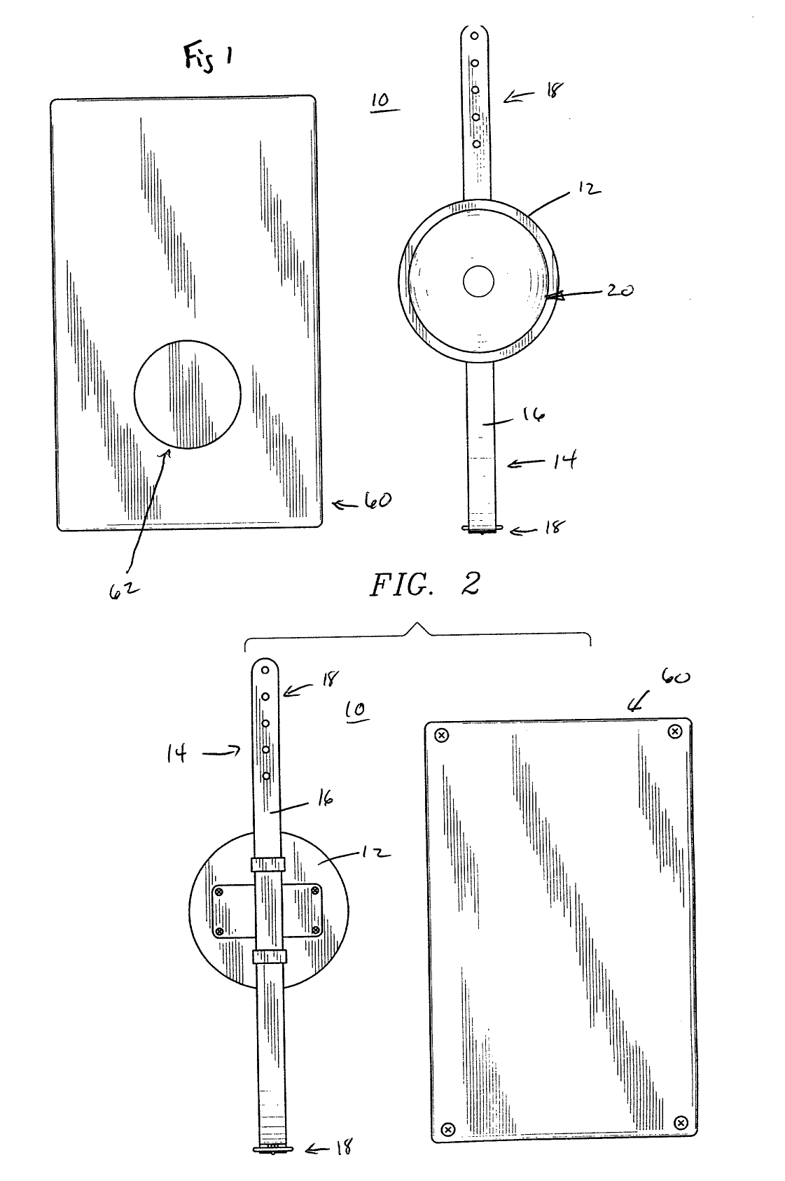

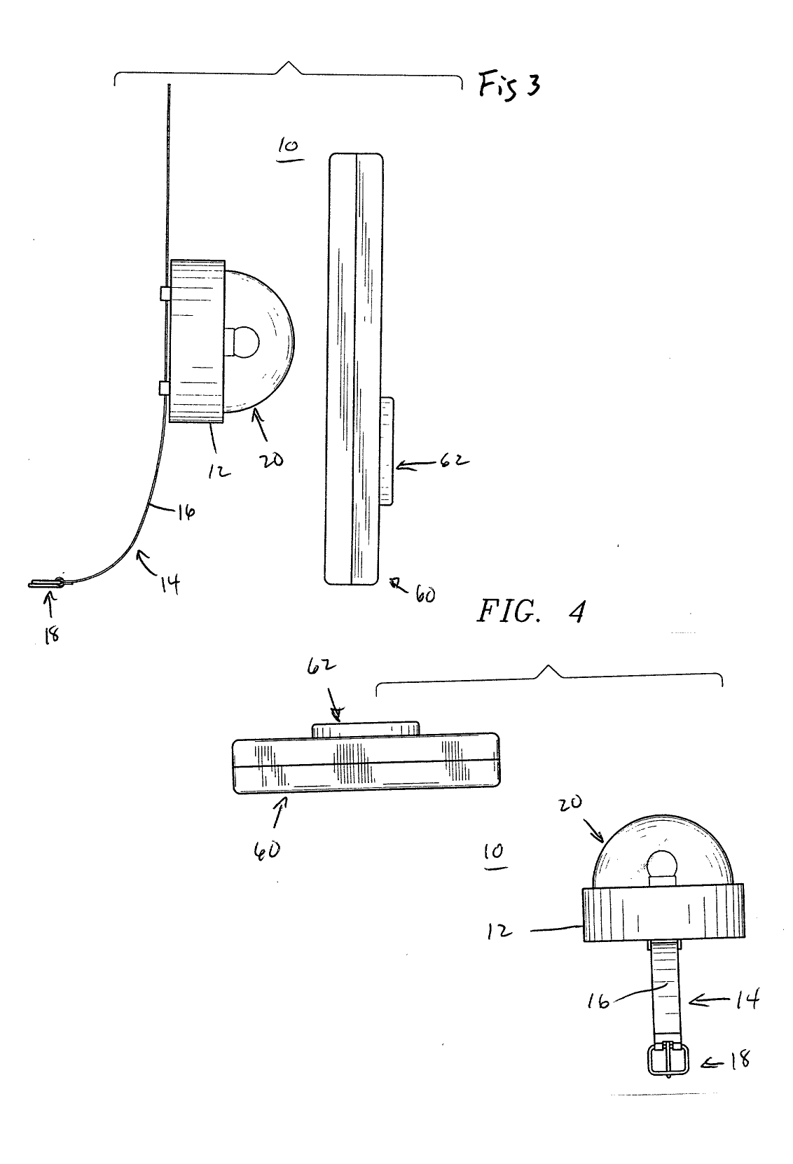

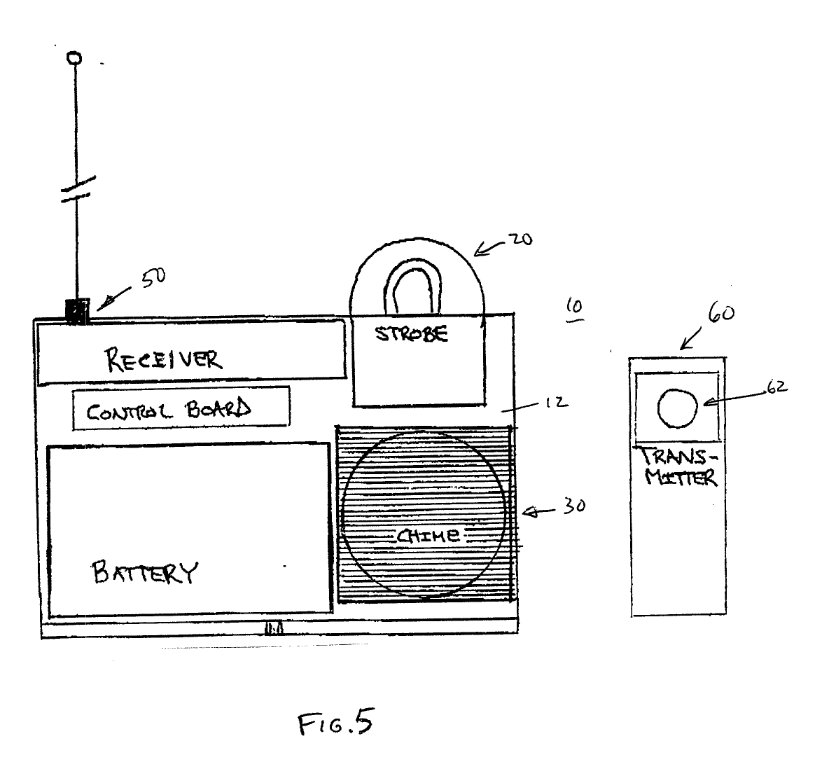

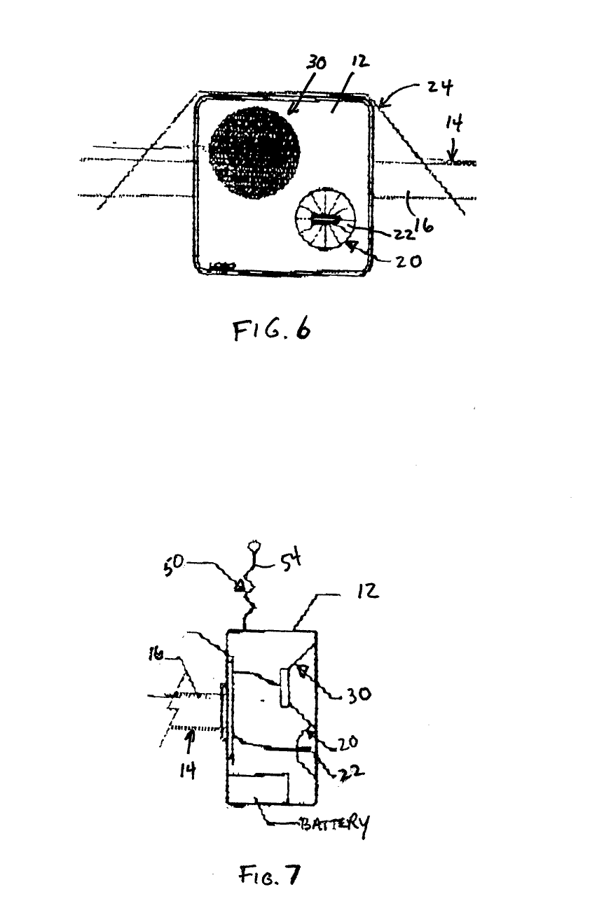

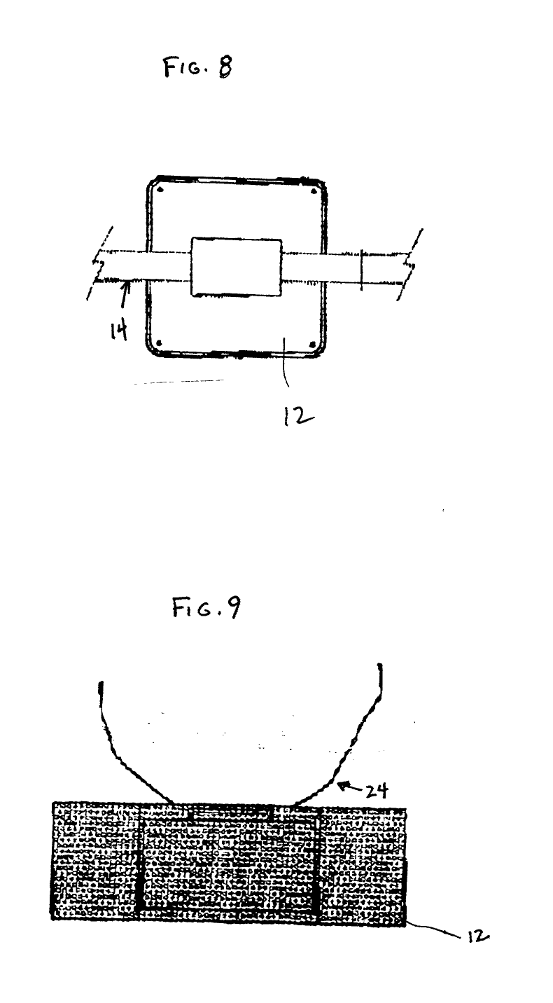

One embodiment of the present invention is shown in FIGS. 1-6. Another illustrative embodiment is shown in FIG. 7. Yet another embodiment is shown in FIGS. 8-11.

The expression “weather proof” is used herein to indicate that the performance of the housing 12 and internal components of the device of the present invention are not adversely affected by, for example, extremes of temperature and moisture. Constructing the device 10 from materials which are able to pass stringent materials performance standards will usually assure that the device performs well in extreme cold or extreme hot and that extremes of temperature will not lead to deterioration of the device over time, leading to performance failure. The housing 12 may be constructed of materials of varying degrees of rigidity. The housing 12 is preferably constructed to withstand extremes of moisture, severe dryness, very high humidity, rain and ice so that the components of the device 10 contained within said housing 12 are not harmed, especially when said housing is properly sealed. A suitable sealing device will prevent moisture from gaining access to said internal components, and may comprise, e.g., a gasket or “O” ring made of material which will not swell or shrink appreciably with changes in temperature, e.g., a synthetic rubber. Such a gasket or “O” ring may be located between an upper casing and a lower casing into which the housing for the locating beacon has been divided. The upper and lower casings are joined together by attachment means capable of applying pressure to the gasket or “O” ring, e.g., threaded fastening means, such as where the housing is round, and snap fitting means, such as where the housing 12 is square or rectangular.

In addition to the harsh outdoor environment, the beacon housing 12 must be securely, and optionally, removably, fastened to an object to be located such as a tree, or another object in the vicinity of the object to be located. The attachment means 14 may be permanent and consist simply of nails, preferably galvanized, which are driven through corresponding holes and which are further preferably located in the perimeter of the housing. Of course, permanently fastening the locating beacon 10 of the present invention implies that the device cannot be removed and used in a different location in the future. Since this may represent an unacceptable expense to the consumer, it is preferred that the attachment means 14 securely, but removably, fasten the locating beacon to the tree or other object to be located. The object to be located will usually be a blind constructed by a hunter in a tree, and the locating beacon will preferably be securely but removably fastened to said blind, or to some part of the tree in which said blind has been constructed.

In order to continuously survive the type of harsh environment usually encountered, the removable attachment means 14 is made from a rugged material having weather resistant properties similar to the material from which the housing 12 for the locating beacon is made. For example, the removable attachment means may comprise one or more galvanized screws or lag bolts that can be used to fasten the locating beacon to an object, e.g., a tree, with removal of the device being accomplished simply by unscrewing the screws or bolts. However, if the device is fastened to a tree by such means the tendency of the tree, as a living entity, to grow and change from, may well result in the screws or bolts being very difficult or impossible to remove. This may even be the case with separate threaded anchors which are mounted into the object such as a tree, after which they are ready to receive threaded fasteners for engagement therewith.

However, it is preferred to use a much simpler system for removably fastening the locating beacon to a tree. Such preferred attachment means 14 comprise one or more straps 16 having engagement means 18 which permit the two ends of the strap to be adjustably joined together and tightened about the trunk or some limb or branch of the tree. The strap or straps 16 have associated means on the housing 12 of the locating beacon 10 which allow the strap or straps to hold the housing against the tree. These associated means preferably allow adjustment of the housing 12, and may consist, e.g., of one or more slots through which the strap or straps are passed. The engagement means 18 permits the two ends of each strap to be adjustably joined together. The engagement means 18 may comprise, e.g., a common buckle and catch with corresponding holes in the strap; a buckle having barbed means which engage the strap otherwise passing freely therethrough when the barbed means is pressed against the strap by movement of the buckle; a double D-ring buckle in which the strap is passed through the double D-ring and back over itself and is held in the desired position thereby; a circular piece on one end of the strap through which the other end of the strap passes back over itself, making a cinch which can be held in position by placing one strap portion against another portion of the strap in such a way as to prevent its movement; a double prong pressure catch with side release; one or more two-part snap catches with a series of bottom grommets into which they can be inserted; or mating fastening means made of hook and loop fabric portions, available commercially such as VELCRO®.

The above-described straps 16 are preferably made of tough, weather resistant materials, which further preferably possess a significant amount of flexibility. Accordingly, materials such as leather, metal mesh, or woven synthetic resins may be used.

Similarly, the locating beacon housing 12 may be slightly flexible so as to conform to the curvature of the trunk or some major limb of a tree to which it is to be attached, although a more significant degree of rigidity will usually be required than is present in the strap attachment means 16. The skilled artisan will be aware of many other materials suitable for use in constructing the housing 12 and attachment means 16 of the locating beacon 10 of the present invention.

The light emitting means 20, which is energized by electrical current, can be fabricated from a number of conventional light sources which are commonly available. However, because of the use environment it is necessary that the light source be visible over a long distance, i.e., for at least about 50 yards, preferably for at least about 300 yards, and most preferably for up to 0.25 mile, i.e., about 440 yards. Consequently, a high intensity light source is required. The light source can be an ordinary incandescent lamp or halogen lamp. A fluorescent lamp may also be used, but these usually fail to provide a sufficient amount of intensity for the longer distances which may be desired or required. The light source may be directional, i. e., focused in a single direction, i.e., focused in several directions, or preferably broadcast omni-directional, i.e., emitted in many, or all, directions. Lenses and/or reflecting means 22 may also be used in conventional arrangements to increase the intensity and range of the emitted light, or to provide a moving beam of light. While ordinary white light, i.e., polychromatic light, will most often be emitted by the light source, it is also possible to produce monochromatic light of any desired color either by choosing a light source suitable for generating light of that color, or by the use of colored filters.

A light source 20 which provides a high intensity light beam capable of traveling over the long distances may require significant amounts of electrical energy. Typically the electrical energy is provided by the energy stored in batteries. It is also usually desirable to lower the consumption of electrical energy as much as possible, while still maintaining the desired qualities of the light which is emitted. One manner in which these objectives can be met is by providing a strobe light, e.g., a flashtube which delivers repeated high-speed illumination of high intensity light. The flashing of the light is thus an aid in finding the object to which the locating beacon is attached. Such strobe lights are of conventional design and may be chosen with the above-described criteria in mind.

The light emitting means 20 is energized by electrical current, and therefore a source of electrical current contained within the housing of the locating beacon must be provided. One or more batteries of conventional design may be employed, provided that they supply the amount of electrical energy required to power the light emitting means for a sufficiently long time and capable of generating a sufficiently strong signal or signals for the user to discover the locating beacon. Since the battery or batteries will usually be located in the weather-proof housing, there is usually no need to use batteries which themselves are weather proof. Moreover, rechargeable batteries may be used. Such batteries may be recharged for their next use, for example directly from the electrical system of the hunter's vehicle, or a replacement set of already fully charged rechargeable batteries may be installed by the hunter.

In a preferred embodiment of the present invention, the source of electrical current comprises an array of solar cells 24 for converting sunlight to electrical energy, preferably located outside said housing 12 to permit an adequate array area. The solar array 24 may be connected to a battery contained within the housing 12 for storing the electrical energy generated by the solar cells until needed to energize the light emitting means 20 and other components of the locating beacon 10 which are energized by electrical current. This embodiment is preferred for applications where the locating beacon 10 may remain dormant for long periods of time. The use of solar cells to generate electrical current on a continuous basis helps to overcomes the depletion of batteries by periodic recharging. The solar cells may be of well-known, conventional construction, comprising a photovoltaic cell, e.g., one including a junction between two different types of silicon semiconductors, that is able to convert sunlight into electrical energy and can thus be used as a power source. A collection of such solar cells is usually referred to as a solar battery or solar panel, the latter term referring to the essentially flat array of the solar cells of which it is comprised.

The present invention preferably provides an array of solar cells 24 which comprises a solar collector means having an associated support means and, optionally, an associated orientation means. The support means typically includes a structural frame which arranges the solar cells in an array as a solar panel or other desired configuration, as well as a structural element which attaches the support means with its array of solar cells to the locating beacon housing. The orientation means is a structure which facilitates orientation of the array of solar cells in a number of different directions, so that the selected display position optimizes the amount of sunlight falling on the solar cells. For example, the orientation means may be a conventional pivot device. Once the sunlight is converted to electrical energy by the solar cells, an electrical circuit means collects the solar-generated electrical energy and delivers the electrical energy to the components of the locating beacon 10. It is preferred that the solar-generated electrical energy first pass into a battery means where the electrical energy may be stored. The number of solar cells which will be required depends on the number and type of components of the locating beacon which are to be energized as well as the anticipated available sunlight, and is well within the skill of the artisan to determine based on calculations well known in the art.

The solar collector means 24 may be located outside the housing 12 in order to facilitate the orientation process if the optional orientation means is used, or if the array of solar cells is too large to be easily accommodated within the housing. The solar collector means 24 may instead be located within the housing 12, thereby benefiting from greater protection from physical damage, as well as providing a more compact and transportable device overall. Where the solar collector means 24 is located inside the housing 12, it will, of course, be necessary to have a window or at least partially transparent section of suitable size therein with a transparent covering thereover. However, orientation of the array of solar cells, if necessary, could be accomplished by positioning the entire locating beacon housing 12 in a desired location.

In addition to the light emitting means 20 provided with the locating beacon device 10 of the present invention, it may be desirable to include a sound emitting means 30. Such a sound emitting means 30 will be energized by the same electrical current as would the light emitting means 20, but will be activated in response to a radio signal frequency generated by the remote control which is different from that which activates the light emitting means 20. It is also possible with regard to adapt the electronic circuitry to use a single radio frequency to activate the light emitting means 20 and/or the sound emitting means 30, using amplitude modulation or amplification to achieve selective activation. The sound emitting means 30 may thus be activated and produce sounds using some of the same components of the locating beacon 10 as the light emitting means 20, e.g., by way of the signal receiving means, circuit means, and the source of electrical current. The sounds may be produced by conventional devices which convert electrical energy into sound energy, and the artisan will have a very broad array of choices of sounds having different tones and timber. The choice will take into consideration the need for the sound to preferably travel over the same range of long distances as above-mentioned for the light emitting means. Moreover, the sound emitting means 30 may be used instead of the light emitting means 20, e.g., where bright sunlight is present which obscures the light signal. Using both the light emitting means 20 and the sound emitting means 30 may also tend to enhance the probability that the user will perceive and recognize one or the other, or both of these signals, especially where trees in a forest through which the user is moving intermittently mask either signal.

The locating beacon 10 also comprises a signal receiving means 50 for receiving a radio signal of specific frequency, or specific frequency range, and circuit means which are responsive to that specific radio signal. The signal receiving means 50 may comprise an antenna array 54 of known construction suitable for receiving the particular radio signal involved. It is preferred that the antenna array be contained within, or at least retractable into, the weather proof housing for the locating beacon so that it is not physically damaged while being transported, installed, or disposed in its final functional location.

In embodiments where a sound emitting means 30 is used in addition to the light emitting means 20, and where each means is selectively activated by signals of different radio frequencies, the signal receiving means 50 and electronic circuit means must be able to differentiate between these two signals and selectively activate the light or the sound emitting means, or both. At a minimum, only one signal receiving means 50 is necessary, e.g. a single radio frequency signal may be used where selective activation takes place using amplitude modulation or amplification which is recognized by the signal receiving means electronic circuit means which responds to differences in amplitude or amplification. Other means of delivering different signals, and the corresponding electronic components necessary to recognize and respond to them in order to achieve selective activation, will readily suggest themselves to the artisan skilled in this field.

Another component of the remotely controlled, long distance locating beacon system for outdoor use of the present invention is the remote control means 60. The remote control means 60 would typically be carried by the user, e.g. a hunter, and used to activate the locating beacon 10 so that the beacon emits light and/or sound, thereby permitting the user to precisely locate an object, such as a hunting blind, to which the locating beacon has been fastened.

The use environment of the remote control means 60 dictates many of its features. For example, it must be compact enough to fit easily into the hand of the user. Its shape and construction must also take into account the fact that it will be used outdoors, often under adverse weather conditions. Accordingly, it is desirable that the remote control device 60 be fabricated from durable but light weight materials, and that it be weather resistant, especially waterproof. It may also be preferred that the buttons or switches which are used to turn the remote control means off and on, and to send the signals which will activate the locating beacon, are flush with the housing for the remote control means.

The remote control means 60 will typically utilize an antenna as part of the signal transmitting means for generating and radiating one or more radio signals of specific frequencies. Such an antenna will be of conventional design and fabricated from materials well known to the artisan. For example, the antenna may be a metallic rod which is preferably telescoping so as to be fully retractable inside the housing for the remote control means. The electronic means which actually generates the radio signals to be radiated by the antenna are well known. Modern technology, especially the use of semiconductors, has greatly simplified the task of miniaturizing these components so that the overall size of the remote control means is kept within the desired bounds. A particular radio frequency, or radio frequency band, such as one which would have the approval of the Federal Communications Commission for use by hunters and others, within the context of the use environment for which the locating beacon of the present invention was developed, would be highly desirable. For example, a radio frequency of 900 megahertz (MHz), which is within the ultrahigh frequency (UHF) class, may be advantageously utilized. Accordingly, the artisan will appreciate that if this radio frequency is used in the device of the present invention, the electronic circuitry and signal transmitting and receiving means will be selected to optimize performance of the device for such transmission and reception.

The source of electrical current needed to energize the signal transmitting means of the remote control means 60 preferably comprises a battery, although it would be possible to power the device directly from the electrical system of the user's vehicle, or some other independent source of electrical energy. These alternate sources of electrical energy may be impractical, however, simply as a consequence of the need for the user to move about in order to discern and locate the light and/or sound signals being emitted by the locating beacon. Thus, the remote 60 may comprise a battery which supplies electrical current for the remote control device. The battery may be conventional, and may further be rechargeable. A nickel-cadmium battery is preferred because of its reliability and endurance.

The remote control device 60 will also have a switching means 62 for controlling the generating of the radio signal. In order to conserve electrical energy, the remote control device 60 will also have an on/off switch, and optionally an on/off switch for the signal generating function. Where both light emitting means and sound emitting means are present on the locating beacon, separate switches for the light emitting means and the sound emitting means may be desirable so that each may be activated separately. Separate switches are not required, however, since the locating beacon may be operated with both a light and a sound signal being simultaneously emitted on all occasions, especially where this is deemed to be the optional operating mode for the locating beacon. The switches that control the radio signal transmission may be simple on/off switches, i.e., once activated (turned on), a radio signal will be continuously transmitted until the switch is deactivated (turned off). The switches that control the radio signal transmission may also be of the intermittent type, i.e., a radio signal is transmitted only so long as the switch is being actively operated. This type of switch prevents the unwanted dissipation of electrical energy where the switch is accidentally left in an activated (on) position. It is also possible to employ switches having both characteristics.

It will thus be seen that the objects set forth above, among those elucidated in, or made apparent from, the preceding description, are efficiently attained, and since certain changes may be made in the above construction without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said to fall therebetween.

What is claimed:

1. A remotely controlled, long distance locating beacon system for locating an object, said system comprising:
a transponder means for generating at least one beacon signal in response to a respective trigger signal; and
a remote trigger means for generating said trigger signal;
wherein said transponder means includes:
a housing having an attachment means for fastening said housing to the object;
receiving means attached to said housing for receiving said trigger signal;
beacon generation means attached to said housing for emitting said beacon signal in response to said trigger signal;
circuit means, disposed within said housing, for connecting said receiving means and said beacon generation means; and
transponder power supply means attached to said housing for supplying electrical power to said receiving means, said beacon generation means, and said circuit means; and
wherein said remote trigger means includes:
transmitter means for generating said trigger signal;
electrical connection means for supplying electrical power to said transmitter means; and
switching means for selectively controlling said transmitter means.

2. The system according to claim 1 wherein said trigger signal is a radio signal within a predetermined frequency range.

3. The system according to claim 1 wherein said beacon generation means further comprises a light emitting means.

4. The system according to claim 3 wherein said light emitting means further comprises at least one high intensity strobe light.

5. The system according to claim 2 wherein said radio signal has a frequency of approximately 900 MHZ.

6. The system according to claim 3 wherein said light emitting means is encased by said housing; and
wherein said housing further comprises at least one transparent portion capable of allowing light from said light emitting means to pass therethrough.

7. The system according to claim 1 wherein said beacon generation means further comprises a sound emitting means.

8. The system according to claim 7 wherein said sound emitting means is encased by said housing; and
wherein said housing is adapted to allow sound from said sound emitting means to pass therethrough.

9. The system according to claim 1 wherein said remote trigger means further comprises a trigger power supply means for supplying electrical power to said transmitter means.

10. The system according to claim 1 wherein said transponder power supply means further comprises at least one battery.

11. The system according to claim 1 wherein said transponder power supply means further comprises a solar collector means.

12. The system according to claim 1 wherein said attachment means further comprises at least one strap attached to the exterior of said housing.

13. A remotely controlled, long distance locating beacon system for aiding a user in locating an object which is at least partially obscured, said beacon system comprising:
a housing having an attachment means for fastening said housing to the object;
receiving means attached to said housing for receiving at least one activation radio signal within a specific frequency range;
beacon generation means attached to said housing for emitting at least one beacon signal in response to said activation radio signal, said beacon generation means including a high intensity light emitting means;
circuit means, disposed within said housing for connecting said receiving means and said beacon generation means;
first power supply means attached to said housing for supplying electricity to said receiving means, said beacon generation means, and said circuit means; and
remote control means including:
signal transmitting means for generating said activation radio signal so as to be capable of detection by said receiving means when said remote control means is spaced apart from said housing; and
switching means for selectively controlling said signal transmitting means;
wherein said activation signal is a radio signal of specific frequency.

14. The system according to claim 13 wherein said light emitting means is disposed within said housing; and
wherein said housing further comprises at least one transparent portion capable of allowing light from said light emitting means to pass therethrough.

15. The system according to claim 13 wherein said beacon generation means further comprises a sound emitting means.

16. The system according to claim 15 wherein said sound emitting means is disposed within said housing; and
wherein said housing is adapted to allow sound from said sound emitting means to pass therethrough.

17. The system according to claim 14 wherein said first electrical power supply means further comprises a solar collector means connected to said circuit means.

18. The system according to claim 14 wherein said remote control means further comprises a power supply means for supplying electrical power to said signal transmitting means.

19. The system according to claim 13 wherein said attachment means further comprises at least one strap attached to the exterior of said housing.

20. A means for marking a location in a wilderness area, including a signal means disposed at the location for generating at least one beacon signal in response to a respective radio trigger signal having a frequency within a predetermined radio frequency range, wherein said signal means includes a replenishable power supply and a remote trigger means for generating the trigger signal in response to user input.
